(19) United States
(12) Patent Application Publication
(10) Pub. No.: US 2022/0029416 A1
(43) Pub. Date: Jan. 27, 2022

(54) DC-POWER SUPPLY DEVICE

(71) Applicant: SIGNIFY HOLDING B.V., EINDHOVEN (NL)

(72) Inventors: MATTHIAS WENDT, Würselen (DE); LENNART YSEBOODT, RETIE (BE)

(21) Appl. No.: 17/293,499

(22) PCT Filed: Nov. 4, 2019
(86) PCT No.: PCT/EP2019/080076

§ 371 Date: May 13, 2021

(51) Int. Cl. H02J 1/00; H02J 13/00; H05B 45/30

(52) U.S. Cl. CPC H02J 1/00; H02J 13/00022; H04L 12/10; H02J 13/00016; H05B 45/30; H02J 13/00002

(57) ABSTRACT

The invention relates to a DC-power supply device (100) for supplying operational DC power to an external DC-powered device (102a) via a wired connection (104. a) that comprises a DC-power output interface (106a), a communication unit (108) configured to receive a shutdown-request signal (S1) indicative of a shutdown time-span (ts) during which no operational DC power is required and to provide a shutdown-trigger signal (52), a DC-powered device detection unit (110a) configured to determine a connected state and a disconnected state of the DC-powered device and to provide a connection status signal (53) indicative thereof and a power control unit (112) configured, upon reception of the shut-down-trigger signal, to disable provision of operational DC power during the shutdown time-span and, upon reception of the connection status signal indicative of the disconnected state, to re-enable provision of operational DC-power, thus improving a control of operational DC power provision.

### FIELD OF THE INVENTION

The present invention is directed to a DC-power supply device, to an electrical arrangement, to a method for operating a DC-power supply device and to a computer program.

### BACKGROUND OF THE INVENTION

U.S. Pat. No. 7,409,566 B1 discloses a detection circuit that monitors a hardware-level signal received from a remote device for voltage transitions indicating that the remote device is connected to a wired connection such as a network cable. If the detection circuit does not sense voltage transitions in the hardware-level signal, it is presumed that the remote device has been unplugged or disconnected from the network cable and the detection circuit generates an immediate or delayed control signal to terminate supplying operational power through the network cable.

US 2007/288784 A1 discloses a method for power over Ethernet comprising: a plurality of power over Ethernet supplying ports; and a management station in communication with each of the plurality of power over Ethernet supplying ports, the management station being operative to: disable at least one first power over Ethernet supplying port of the plurality of power over Ethernet supplying ports on a predetermined scheduled basis. The management station is further operative to receive an entry indication; and enable the disabled at least one first power over Ethernet supplying port responsive to the received entry indication.

### SUMMARY OF THE INVENTION

It would be beneficial to improve a control of provision of operational DC power to DC-powered devices connected to a DC-power supply device.

According to a first aspect of the present invention, a DC-power supply device for supplying operational DC power to an external DC-powered device via a wired connection is provided. The DC-power supply device comprises a DC-power output interface for providing the operational DC power to the DC-powered device via the wired connection. The DC-power output interface is operable in a power-provision-enabled mode in which operational DC power is deliverable to the DC-powered device upon request, and in a power-provision-disabled mode in which operational DC power is not deliverable to the DC-powered device. The DC-power supply device also comprises a communication unit configured to receive a shutdown-request signal indicative of a shutdown time-span during which no operational DC power is required by the DC-powered device via the DC-power output interface, and to provide a shutdown-trigger signal indicative thereof. Additionally, the DC-power supply device comprises a DC-powered device detection unit configured to detect a connected state, in which a DC-powered device is connected to the DC-power output interface via the wired connection, and to detect a disconnected state, in which the wired connection is disconnected, and to provide a connection status signal indicative thereof and a power control unit connected to the DC-power output interface, to the communication unit and to the DC-powered device detection unit and configured to receive the shutdown-trigger signal and the connection status signal, upon reception of the shutdown-trigger signal, to drive operation of the DC-power output interface in the power-provision-disabled mode during the shutdown time-span, and, upon reception of the connection status signal indicative of the disconnected state, to drive operation of the DC-power output interface in the power-provision-enabled mode, even when the shutdown time-span has not lapsed.

The DC-power supply device of the present invention achieves an improved managing of the provision of operational DC power to a connected external DC-powered device.

The DC-power output interface of the DC-power supply device for providing the operational DC power to the DC-powered device via the wired connection is operable in two different operational modes:

a) In a first operational mode, referred to herein as power-provision-enabled mode, provision of operational DC power from the DC-power supply device to the external DC-powered device via the wired connection is enabled, so that, if there is a request for power for the external DC-powered device, operational DC power can be delivered via the wired connection.

b) In a second operational mode, referred to herein as power-provision-disabled mode, provision of operational DC power is not deliverable, or, put in other words, not allowed. When the DC-power output interface of the DC-power supply device is in the power-provision-disabled mode, no operational DC power can be provided via the DC-power output interface and the wired connection to the external DC-powered device, regardless of whether or not operational DC power is requested to operate the external DC-powered device. Thus, when operating in the power-provision-disabled mode, no operational DC power can be drawn from the DC-power output interface.

The DC-power supply of the first aspect of the invention is thus configured to operate in both operational modes, but only one of the operational modes is active for a given wired connection at a given point in time.

The communication unit of the DC-power supply device is configured to receive a shutdown-request signal. The shutdown-request signal comprises information regarding a time span, namely a shutdown time-span, in which no operational DC power will be needed by the DC-powered device. Upon reception of the shutdown-request signal, the communication unit provides a shutdown-trigger signal indicative of the shutdown time-span to the power control unit.

The DC-power supply device also comprises a DC-powered device detection unit which is configured to determine whether or not the DC-powered device is connected to the DC-power supply device via the wired connection. The DC-powered device detection unit determines a connection status of the DC-powered device, i.e. it detects whether the DC-powered device is in a connected state, wherein the DC-powered device is connected to the DC-power output interface via the wired connection, or whether the wired connection has been disconnected, and therefore the DC-powered device is in a disconnected state.

It is noted that an external DC-powered device which is not currently requesting operational DC power because it has been switched-off, for instance by using an internal switch thereof, but which is still connected to the DC-power supply device via the wired connection, is considered to be in a connected state. This is due to the fact that the wired connection still connects the DC-power supply device to the external DC-powered device. Thus, the connected state is not an indication of whether the DC-powered device is receiving operational DC power or not, but rather an indication of whether there is a wired connection connecting the DC-power supply device and the DC-powered device.

The DC-powered device detection unit is also configured to provide a connection status signal indicative of whether the external DC-powered device is in a connected state or in a disconnected state.

Further, the DC-power supply device of the first aspect comprises a power control unit which is configured to receive the shutdown-trigger signal from the communication unit and the connection status signal from the DC-powered device detection unit. When the power control unit receives the shutdown-trigger signal, which indicates that the external DC-powered device will not require DC-operational power for a given shutdown time-span, the power control unit drives the DC-power output interface to operate in the power-provision disabled mode for the duration of the shutdown time-span. While operating in the power-provision-disabled mode, no operational DC power can be provided to the external DC-powered device under any circumstances.

While operating in the power-provision-disabled mode, the DC-power supply device is configured to determine a connection status, namely one of a connected state and a disconnected state of the external DC-powered device, as explained above. When a connection status signal is received by the power control unit that indicates that the external DC-powered device is in a disconnected state, i.e. that the wired connection is disconnected, the control unit is configured to drive the DC-power output interface to operate in the power-provision enabled mode, even in the shutdown time-span has not yet lapsed.

Thus, the determination of a disconnected state while operating in the power-provision-disabled mode results in the DC-power supply device, and more specifically the DC-power output interface, changing its operational mode to the power-provision-enabled mode. In other words, unplugging the external DC-powered device from the DC-power supply device by disconnecting the wired connection between them forces an end of the shutdown time-span even if the shutdown time-span has not yet lapsed. Thus, sending the connection status signal to the power control unit for controlling the operational mode of the DC-power output interface has the advantage that the duration of the shutdown time-span can be reduced ad-hoc if the wired connection is disconnected before the shutdown time-span has lapsed. This enables the provision of operational DC-power before the shutdown time-span has lapsed in cases where the DC-powered device has been disconnected from the DC-power supply device and the same or another external DC-powered device has been connected to the same DC-power output interface.

It should be noted, that enabling or disabling the provision of operational DC power is to be distinguished from providing or discontinuing provision of said operational DC power. Enabling the provision of operational DC power is a precondition for the actual provision of the DC power. Even if no DC power is provided, the provision of DC power may be enabled.

The DC-power supply device of the first aspect of the present invention is thus advantageously configured to improve control of power delivery to DC-powered devices connected thereto.

In the following, embodiments of the DC-power supply device of the first aspect of the present invention will be described.

In preferred embodiments, the DC-power supply device comprises a plurality of DC-power output interfaces, which each serve for providing DC power via a respective wired connection. The improved functionality of the DC-power supply device of the present invention is preferably implemented for each of its DC-power output interfaces. However, in some other embodiments, the improved functionality of the DC-power supply device of the present invention is implemented for only some of the DC-power output interfaces. For other of the DC-power output interfaces, there is no detection of a connected or disconnected state, and, accordingly, the power control unit in these other embodiments controls power delivery via these other DC-power output interfaces in response to a shutdown-request signal without distinguishing between the connected state and the disconnected state.

The shutdown-request signal is in some embodiments indicative of a request of an immediate interruption of the provision of operational DC power for the duration of the shutdown time-span. In other embodiments, the shutdown-request signal is indicative of a request to interrupt the provision of operational DC power at a given point in time other than the current point in time. The shutdown time-span can have time span values ranging from zero, to infinity. A value of infinity means that the DC-power output interface will be operating in the power-provision-disabled mode unless (and until) the wired connection is disconnected.

Driving the operation of the DC-power output interface in the power-provision-enabled mode and in the power-provision-disabled mode is in one particular embodiment performed by controlling a switching unit that allows or prevents provision of operational DC power to the DC-power interface. In another embodiment, the operation in the power-provision-enabled mode and in the power-provision-disabled mode is a process that is software-controlled by a central processing unit or a microprocessor.

In a particular embodiment, the DC-power supply device comprises a plurality of DC-power output interfaces, each configured to provide respective operational DC power to a respective external DC-powered device. In this embodiment, each of the DC-power output interfaces is configured to operate in the power-provision-enabled mode and in the power-provision-disabled mode independently on the current operational mode of the rest of the DC-power output interfaces.

In a preferred embodiment in accordance with the first aspect of the invention, the power control unit is further configured to drive operation of the DC-power output interface in the power-enabled mode upon expiration of the shutdown time-span. Thus, when the shutdown time-span lapses and the connection status has not changed from a connected state to a disconnected state, the power control unit drives the DC-power interface for operating in the power-provision-enabled mode, where the DC-power supply is configured to provide operational DC power upon request. In other words, after the shutdown time-span has lapsed, this embodiment of a DC-power supply device is configured to re-enable provision of power to the DC-power supply device by driving operation of the DC-power output interface in the power-provision-enabled mode.

In an embodiment of the DC-power supply device, the DC-powered device detection unit, for detecting whether a DC-powered device is connected to the DC-power output interface, is configured to generate and provide, via the control the DC-power output interface and via the wired connection, an electrical test signal having a predetermined voltage amount, to determine whether or not a current amount provided via the DC-power output interface in response to the electrical test signal has a current value within a predetermined current value range, and to provide the connection status signal in dependence thereof. It is here noted that, although the electrical test signal transfers an amount of electrical power to the external DC-powered device connected via the wired connection, that amount of power is not considered as operational DC power. Advantageously, the voltage amount of the electrical test signal is comparatively low so as to maintain a low power consumption during stand-by operation of the DC-powered device, i.e. DC-powered device not operating but connected to the DC-power supply device and ready to request operational DC-power, and thus the electrical test signal does not provide enough electrical power to operate the DC-powered device.

Alternatively, in another embodiment of the DC-power supply device, the DC-powered device detection unit, for detecting whether a DC-powered device is connected to the DC-power output interface, is configured to generate and provide, via the DC-power output interface, and via the wired connection, an electrical test signal having a predetermined voltage amount, to determine whether or not an effective resistance connected to the DC-power output interface via the wired connection has a resistance value within a predetermined resistance value range, and to provide the connection status signal in dependence thereof.

In another embodiment, and regardless of whether the connection status signal is provided in dependence on the determination of a current value or of a resistance value, the DC-powered device detection unit is configured to generate and provide the DC-power output interface to provide the electrical test signal as a pulse train, each pulse of the pulse train having a non-vanishing voltage amount only during a predetermined pulse-time span, the pulse train thus having a vanishing voltage amount between individual pulses, and wherein the DC-powered device detection unit is configured to distinguish between the connected state and the disconnected state based on the current amount or the effective resistance detected during the pulse-time spans only. Thus, the connections status is only significantly determined during the pulse-time span and not during the time at which the pulse train has a vanishing voltage value. The provision of test signals in the form of a pulse train as described herein further reduces the power consumption in stand-by conditions, i.e. when the DC-powered device is not operating but it is still connected to the DC-power supply device via the wired connection and ready to request operational DC power.

In another embodiment, the communication unit comprises a wireless-signal input unit that is configured to receive the shutdown-request signal via a wireless connection in accordance with a predetermined wireless communication protocol. This particular communication unit comprising a wireless-signal input unit can be implemented in any of the embodiments of the DC-power supply device of the first aspect described above.

Additionally, or alternative, in another embodiment, the communication unit is configured to receive the shutdown-request signal via the wired connection. This is particularly advantageous in systems wherein power and communication signals are transmitted over the same wired connection. In this embodiment, the wired connection is suitable for transmitting both operational DC power from the DC-power supply device to the DC-powered device and also communication signals in accordance with a predetermined communication protocol, the shutdown-request signal being a communication signal in this sense. Also, in this embodiment, the DC-power output interface is further configured to receive the shutdown-request signal and provide it to the communication unit. In another embodiment, the DC-power output interface forms part of an output interface to which the wired connection is connected. This output interface also comprises a communication-signal interface configured to receive the shutdown-request signal.

In a particular embodiment comprising more than one DC-power output interface, one or more external DC-powered devices are connected to a respective DC-power output interfaces. In this embodiment, the shutdown request signal can be received by one of the several DC-power output interfaces via a wired connection but may be directed for controlling the operational mode of a different DC-power output interface.

Additionally, or alternatively, in another embodiment, at least one of the DC-power output interfaces is configured to be connected to an external system control device suitable for providing respective shutdown-request signals for the external DC-powered devices connected to the DC-power supply device.

A particular embodiment wherein the communication unit is configured to receive the shutdown-request signal via the wired connection, is configured to operate as a Power Sourcing Equipment (PSE) in the sense of the Power over Ethernet (PoE) technology, which relies on an Ethernet wired connection to transmit both operational power as well as communication signals in accordance with a predetermined communication protocol. In this embodiment, the communication unit is configured to receive the shutdown-request signal via the wired transmission in accordance with a IEEE 802.3 protocol, in particular a IEEE 802.3 BASE-T Ethernet communication protocol.

Particularly, in one embodiment, the communication unit is configured to receive the shutdown-request signal as a Logical Link Discovery Protocol frame in accordance with a Logical Link Discovery Protocol (LLDP).

In another embodiment, the communication unit is configured to receive the shutdown-request signal forming part of a “Power down” field of the Logical Link Discovery Protocol.

The Power over Ethernet standard IEEE 802.3bt introduces new fields as part of the Power over Ethernet specific part of the LLDP protocol. The LLDP protocol is used by devices connected to each other via a wired connection in the form of an Ethernet link to exchange information with each other. Usually, the information exchange pertains to the status of the devices on each end of the Ethernet link. The LLDP protocol is expandable by nature. The amendments introduced by IEEE P802.3bt add several features to the LLDP protocol. For instance, a feature referred to as “power down” field is defined in clause 79.3.2.6g, and allows the external DC-powered device, compliant with the Power Over Ethernet technology, to indicate to the DC-powered supply device, i.e., the Power Sourcing Equipment in the case of PoE, that it no longer requires power and may be shut down, i.e. provision of operational power may be discontinued. This is particularly advantageous to reduce power consumption during stand-by operation. Additionally, the DC-powered device can also indicate the time span it would like to remain unpowered. This time span is referred to as the shutdown time-span and can be also set to infinite, i.e. the DC-power device does not longer require operational DC-power at all. However, in the majority of cases, the shutdown-request signal will be indicative of a finite shutdown time-span during which the DC-powering device wishes to be shut down.

After the shutdown time-span has lapsed, the DC-power supply device, in this case acting as a PSE. is configured to re-enable provision of power to the DC-power supply device by driving operation of the DC-power output interface in the power-provision-enabled mode.

Additionally, the DC-power supply device, acting as a PSE, is conveniently configured to determine whether or not the external DC-powered device is connected or not to the DC-power supply device via the wired connection. IEEE 802.3 defines a detection process wherein all connected DC-powered devices compliant with the technology are required to connect an effective resistance of 25 kilo-ohms when exposed to voltages with a voltage values between 2.7 and 10.1 V. A PSE is only allowed to provide operational DC power when it can detect such an effective resistance. This prevents the risk of providing power to an open connection. The DC-powered device detection unit is thus configured to provide the connection status signal in dependence on whether the detection process was successful i.e. a DC-powered device compliant with the PoE technology is connected via the wired connection, or was not successful i.e. the wired connection between the DC-powered device and the DC-power supply device that were connected, has been in the meantime disconnected.

Sending the connection status signal to the power control unit has the advantage that the time length of the shutdown time-span can be reduced ad-hoc if the wired connection is disconnected before the shutdown time-span has lapsed.

For instance, if any of the embodiments of a DC-power supply device discussed above, not necessarily compliant with the IEEE 802.3 protocol, receives a shutdown-request signal for ceasing provision of operational DC power to an external DC-powered device connected via a wired connection to the DC-power output interface for a given shutdown-time lapse, which can be even set to last an infinite time, provision of operational DC power from that particular DC-power output interface is no longer allowed for the duration of the shutdown-time lapse. Without providing a mechanism to override such prohibition, even if the DC-powered device is disconnected and a new one connected to the same DC-power output interface, this newly connected device would not receive operational DC power until the shutdown time-span has expired

According to a second aspect of the present invention, an electrical arrangement is described. The electrical arrangement comprises a DC-power supply device in accordance to the first aspect of the invention or to any of its embodiments, a DC-powered device and a shutdown-condition determination unit. The DC-powered device is connected to the DC-power supply device via the wired connection, and comprises a DC-power input interface for receiving the operational DC electrical power from the DC-power supply device via the wired connection. The shutdown-condition control unit comprises a shutdown-condition determination unit that is configured to determine, based on a fulfillment of a predetermined shutdown condition, whether a shutdown of the DC-powered device is required for a predetermined shutdown time-span. The shutdown-condition control unit also comprises a shutdown-condition communication unit that is connected to the shutdown-condition determination unit and configured to provide, upon fulfillment of the shutdown condition, the shutdown-request signal to the DC-power supply device.

The electrical arrangement of the second aspect thus shares the advantages of the DC-power supply device of the first aspect or of any of its embodiments.

In the following, embodiments of the second aspect of the present invention will be presented.

The shutdown-condition determination unit comprises in an embodiment a sensing unit, a timing unit or a combination thereof. The sensing unit comprises, for instance, a presence sensor, a light sensor, a temperature sensors or other sensors related to the specific functionality of the DC-powered device.

In a particular embodiment, the DC-powered device comprises the shutdown-condition control unit as an internal unit. In this embodiment, the shutdown-condition control unit is connected to the DC-power input interface. In a particularly advantageous embodiment, the shutdown-condition control unit is configured to receive operational DC power from the DC-power supply device via the wired connection. In an alternative embodiment, the shutdown-condition control unit is powered by an internal power supply device such as a battery. The DC-powered device is thus configured to determine whether a shutdown of the DC-powered device is required for a predetermined shutdown time-span and to provide the shutdown-request signal to the DC-power supply device. The provision of the shutdown-request signal is, in an embodiment, provided to the DC-power supply device via the wired connection. In another embodiment, the provision of the shutdown-request signal is additionally or alternatively done wirelessly based on a wireless communication protocol. In this embodiment, the DC-power supply device further comprises a wireless communication unit as described above with reference to a particular embodiment of the first aspect of the invention.

In a preferred embodiment, the DC-powered device comprises a lighting device for providing indoor or outdoor illumination, the lighting device being configured to receive operational DC-power from the DC-power supply device via the wired connection. As an example, the lighting device comprises, in an embodiment, a shutdown-condition determination unit that comprises a presence sensor and a timing unit, and that is configured to provide the shutdown-request signal when no presence has been detected for a given time span after a given hour, for example, no presence detected in the last 30 minutes at a time after 9 PM. The lighting device may then conclude that it can safely be shut down until the next morning and then send the shutdown-request signal requesting an interruption of the provision of operational power for the shutdown time-span. If during the shutdown time-span, the lighting device is disconnected, the DC-power output interface returns to the power-provision-enabled operational mode, so that if a new DC-powered device is connected, or the same one re-connected, operational DC power can be supplied to it when required. The lighting device preferably comprises a plurality of LED for providing the indoor or outdoor illumination.

According to a third aspect of the present invention, a method for operating a DC-power supply device for supplying operational DC power to an external DC-powered device via a wired connection is described. The DC-power supply device has a DC-power output interface for providing the operational DC power to the DC-powered device via the wired connection, the DC-power output interface being operable in a power-provision-enabled mode in which operational DC power is deliverable to the DC-powered device upon request, and in a power-provision-disabled mode in which operational DC power is not deliverable to the DC-powered device. The method comprises:
receiving a shutdown-request signal indicative of a shutdown time-span during which no operational DC power is required by the DC-powered device via the DC-power output interface and providing, to a power control unit, a shutdown-trigger signal indicative thereof;
determining a connected state, in which a DC-powered device is connected to the DC-power output interface via the wired connection, and a disconnected state, in which the wired connection is disconnected, and providing, to a power control unit, a connection status signal indicative thereof; and
upon reception of the shutdown-trigger signal, driving operation of the DC-power output interface in the power-provision-disabled mode during the shutdown time-span; and
upon reception of the connection status signal indicative of the disconnected state, driving operation of the DC-power output interface in the power-provision-enabled mode, even when the shutdown time-span has not lapsed.

The method of the third aspect of the invention shares the advantages of the DC-power supply of the first aspect or of any of its embodiments.

According to a forth aspect of the present invention, a computer program is described that comprises instructions which, when the program is executed by a computer, cause the computer to carry out the method of the third aspect of the invention.

It shall be understood that the DC-power supply device of claim 1, the electrical arrangement of claim 10, and the method of claim 14, and the computer program of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a block diagram of an embodiment of a DC-power supply device connected, via a wired connection, to two external DC-powered devices, all forming an electrical arrangement.

FIGS. 2a and 2b show time diagrams describing the interaction of the shutdown-request signal and the connection status signal with the operational mode of the DC-power output interface of a DC-power device supply.

FIG. 3 shows a time diagrams describing the interaction between the response to electrical test signals and the connection status signal.

FIG. 4 shows a block diagram of another embodiment of a DC-power supply device connected, via a wired connection, to two external DC-powered devices.

FIG. 5 shows a flow diagram of an embodiment of a method for operating a DC-power supply device.

### DETAILED DESCRIPTION OF EMBODIMENTS

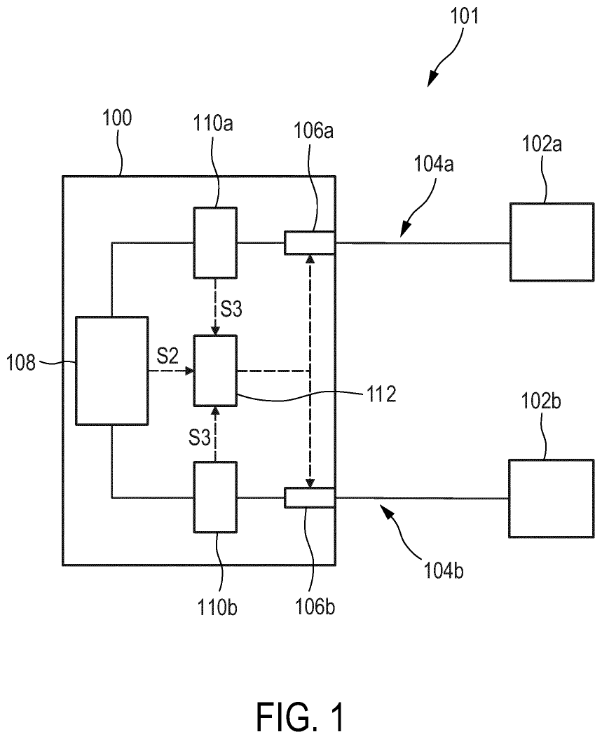

FIG. 1 shows a block diagram of an embodiment of an electrical arrangement 101 comprising a DC-power supply de-vice 100 connected, via a respective wired connection 104a, 104b, to two external DC-powered devices 102a, 102b.

The DC-power supply device 100 is configured to supply operational DC power to the external DC-powered devices 102a, 102b via the wired connections 104a, 104b. This exemplary DC-power supply device comprises two DC-power output interfaces 106a, 106b for providing the operational DC power to the respective DC-powered devices. Other DC-power supply devices that are not shown comprise one, three or more DC-power output interfaces. Each DC-power output interface is operable in a power-provision-enabled mode in which operational DC power is deliverable to the DC-powered device upon request, and in a power-provision-disabled mode in which operational DC power is not deliverable to the DC-powered device under any circumstance. The operational mode of any DC-power output interface does not depend on the operational mode of the remaining DC-power output interfaces. The DC-power supply device also comprises a communication unit 108 configured to receive a shutdown-request signal indicative of a shutdown time-span during which no operational DC power is required by the DC-powered device, and to provide a shutdown-trigger signal S2 indicative thereof. Additionally, DC-powered device detection units 110a, 110b are configured to determine a connected state, in which a DC-powered device is connected to a respective DC-power output interface via the wired connection, and a disconnected state, in which the wired connection is disconnected, and to provide a connection status signal S3 indicative thereof. FIG. 1 shows a DC-powered device detection unit for each of the DC-power output interfaces. Alternative DC-power supply devices (not shown) comprise a single DC-powered device detection unit connected to all of the DC-power output interfaces.

Both the shutdown-trigger signal S2 and the connection status signal S3 are provided to a power control unit 112 that is connected to the DC-power output interface, to the communication unit and to the DC-powered device detection unit.

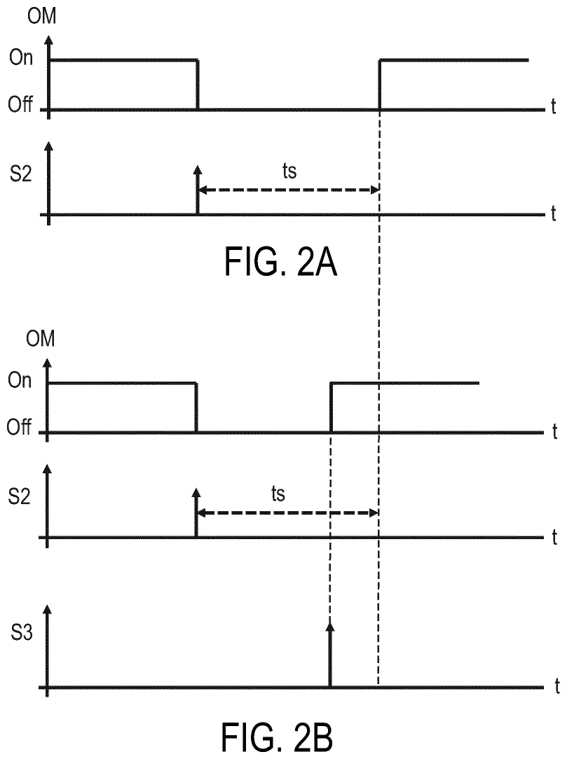

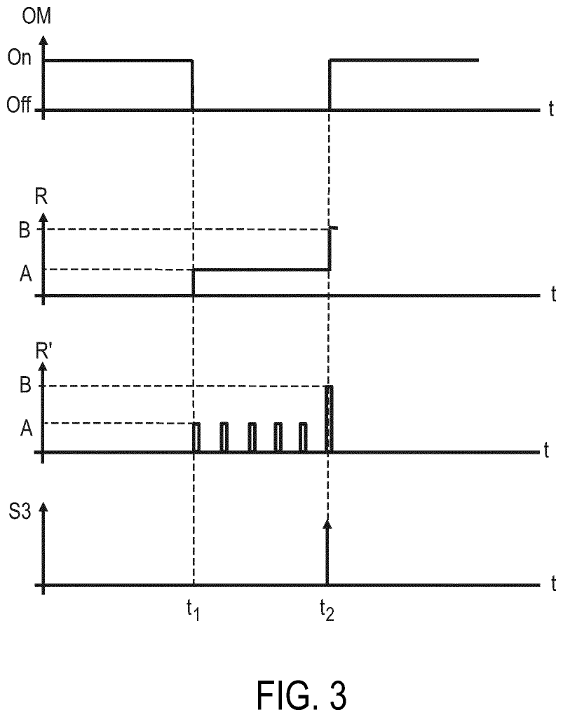

FIGS. 2a and 2b show time diagrams describing the interaction of the shutdown-request signal S2 and the connection status signal S3 with the operational mode OM of the DC-power output interface of a DC-power device supply. The operational mode OM is, at a given time, one of a power-provision-enabled mode, indicated as On in FIGS. 3a and 3b, and in which operational DC power is delivered to the DC-powered device upon request, and a power-provision-disabled mode, indicated as Off in FIGS. 2a and 2b, and in which operational DC power is not delivered to the DC-powered device under any circumstances. Upon reception of the shutdown-trigger signal S2 the power control unit 212 is configured to drive operation of the DC-power output interface in the power-provision-disabled mode Off during the shutdown time-span ts. In FIG. 2a, no connection status signal indicative of a disconnection of the wired connection is received by the power control unit during the shutdown time-span ts. Therefore, once the shutdown time-span has expired, the operational model OM changes to a power-provision-enabled mode On. In the example shown on FIG. 2b, a connection status signal S3 indicative of a disconnection of the wired connection is received before the expiration of the shutdown time-span. The reception of this connection status signal causes the power control unit to drive operation of the DC-power output interface in the power-provision-enabled mode On.

Therefore, upon reception of the connection status signal indicative of the disconnected state, the power control unit is configured to drive operation of the DC-power output interface in the power-provision-enabled mode, even when the shutdown time-span has not lapsed. In particular, in the case of a DC-supply device compliant with IEEE 802.3. and Power over Ethernet, when the connection status signal indicative of the disconnected state is received, the DC-power supply device suitably starts a DC-powered device detection routine. Thus, a shutdown time-span can be interrupted by removing the connection between the DC-power supply device and the DC-powered device. Alternatively, when the connection status signal indicative of the disconnected state is received, the DC-power supply device starts provision of operational DC power. Since no DC-powered device is connected via the wired connection to the DC-power supply device, no maintain power signature is detected and, in accordance with the Power over Ethernet standard, the provision of operational DC power will be stopped after a predetermined time span and the DC-power supply device will start the DC-powered device detection routine.

For determining whether a DC-powered device is connected to the DC-power output interface, the DC-powered device detection units 106a, 106b are configured to control the DC-power output interface to provide, via the wired connection 104a, 104b, an electrical test signal having predetermined voltage amount, to determine whether or not a current amount drawn at the DC-power output interface has a current value belonging to a predetermined current value range, and to provide the connection status signal in dependence thereof. It is however noted that, although the electrical test signal transfers an amount of electrical power to the external DC-powered device connected via the wired connection that amount of power is not considered as operational DC power.

In another exemplary DC-power supply device, the DC-powered device detection unit is alternatively or additionally configured, based on a response to the electrical test signal, to determine whether or not an effective resistance connected to the DC-power output interface via the wired transfer has a resistance value belonging to a predetermined resistance value range, and to provide the connection status signal in dependence thereof.

Further, and regardless of whether the connection status signal is provided in dependence on the determination of a current value or of a resistance value, the device detection unit of another exemplary DC-power supply device is configured to control the DC-power output interface to provide the electrical test signal as a pulse train, each pulse lasting a predetermined pulse-time span, the pulse train having a vanishing voltage amount between pulses, and wherein the DC-powered device detection unit is configured to determine the connected status only in dependence on a detected response to the pulses. Thus, the connections status is only determined during the pulse-time span and not during the time at which the pulse train has a vanishing voltage value. The provision of test signals in the form of a pulse train as described herein further reduces the power consumption in stand-by situations, i.e. when the DC-powered device is not operating but it is still connected to the DC-power supply device via the wired connection.

This is shown with reference to FIG. 3, which shows time diagrams describing the interaction between the response to electrical test signals and the connection status signal. At a time t₁ the power control unit receives a shutdown-trigger signal (not shown) that results in the DC-power output interface operating in an Off mode, as explained with reference to FIGS. 3a and 3b above. From t₁ onwards, the DC-power supply device provides electrical test signals to determine whether or not the external DC-powered device is in a connected state or in a disconnected state. FIG. 3 shows the response R, R′ to the electrical test signals provided and can be either a measured current value drawn at the DC-power output interface or a value of an effective resistance determined at the DC-power output interface. R is an exemplary response, in terms of determined effective resistance, to an electrical test signal that is has a constant voltage value for a whole duration of a test phase. R′ is an exemplary response, also in terms of effective resistance, to an electrical test signal that is pulse train with vanishing voltage vales between pulses. Between times t1 and t2, the DC-powered device is connected to the DC-power supply device via the wired connection. In this case, the determined value of the response R to the electrical test signals is a determined effective resistance of constant value A which is interpreted as a connection status being that of a connected state. At time t2 the wired connection is disconnected and thus the response R to the test signal varies. This variation is interpreted as a connection status changing from the connected state to the disconnected state and causes the power control unit to drive operation of the DC-power output interface in the power-provision-enabled mode. In the case of response R′, the determination of the connection status is performed only during the pulses, i.e. during those phases of the pulse train where the electrical test signal does not have a vanishing voltage value. Only at those moments, the effective resistance is measured and a change of the connection status from a connected state to a disconnected state can be determined. Thus, if the disconnection happens at a time where the electrical test signal has a vanishing voltage value, the detection of the change of connection status will be determined during the next pulse.

In the DC-power supply device 100, the shutdown-request signal is provided via the wired connection 104a, 104b by a DC-powered device. Here, the DC-power output interface 106a, 106b is further configured to receive the shutdown-request signal and provide it to the communication unit 108. Alternatively, in an exemplary DC-power supply device, the DC-power output interface forms part of an output interface to which the wired connection is connected. The output interface also comprises a communication-signal interface configured to receive the shutdown-request signal.

A preferred DC-power supply device is configured to act as a power sourcing equipment PSE in the sense of Power over Ethernet (PoE) technology in accordance with the IEEE 802.3 standard. In this exemplary DC-power supply device the DC-power output interface comprises an Ethernet connector to which an Ethernet cable can be connected. The Ethernet cable is a wired connection in the sense of this discussion and it is configured to transfer operational DC power from the DC-power supply device to the external DC-powered device connected thereto. The DC-power output interface and the wired connection are also configured to transfer communication signals using a predetermined communication protocol, the shutdown-request signal being a communication signal in this sense.

The Power over Ethernet standard IEEE 802.3bt introduces new fields as part of the Power over Ethernet specific part of the LLDP protocol. The LLDP protocol is used by devices connected to each other via a wired connection in the form of an Ethernet link to exchange information with each other. Usually, the information exchange pertains to the status of the devices on each end of the Ethernet link. The LLDP protocol is expandable by nature. The amendments introduced by IEEE P802.3bt add several features to the LLDP protocol. For instance, a feature referred to as “power down” field is defined in clause 79.3.2.6g, and allows the external DC-powered device, compliant with the Power Over Ethernet technology, to indicate to the DC-powered supply device, i.e., the Power Sourcing Equipment in the case of PoE, that it no longer requires power and may be shut down, i.e. provision of operational power may be discontinued. This is particularly advantageous to reduce power consumption during stand-by operation. Additionally, some DC-powered devices are configured to indicate the time span it would like to remain unpowered. This time span is referred to as the shutdown time-span and can be also set to infinite, i.e. the DC-power device does not longer require operational DC-power at all. However, in the majority of cases, the shutdown-request signal will be indicative of a finite shutdown time-span during which the DC-powering device wishes to be shut down.

Additionally, the DC-power supply device, acting as a PSE, is conveniently configured to determine whether or not the external DC-powered device is connected or not to the DC-power supply device via the wired connection. IEEE 802.3 defines a detection process wherein all connected DC-powered devices compliant with the technology are required to connect an effective resistance of 25 kilo-ohms when exposed to voltages with a voltage values between 2.7 and 10.1 V. Thus, in this particular DC-power supply device, the electrical test signal is a voltage signal, preferably a pulsed voltage signal in the form of a voltage pulse train, with voltage values between 2.7 and 10.1 V, and zero between pulses, in the case that the signal is a pulse train. A PSE is only allowed to provide operational DC power when it can detect an effective resistance of 25 kilo-ohms when applying said voltage range. Thus, the DC-powered device detection unit is configured to determine the value of the effective resistance at the DC-power output interface and to determine a connected state when the value of the effective resistance is 25 kilo-ohms, and a disconnected state, otherwise.

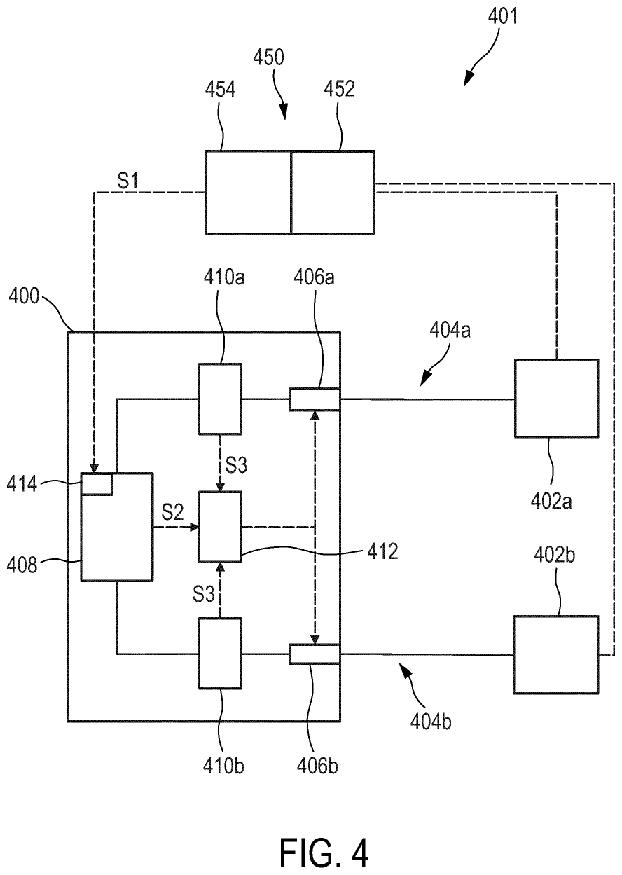

FIG. 4 shows another embodiment of an electrical arrangement 401. The following discussion will be focused on those features that are different when comparing the electrical arrangement 101 of FIG. 1 to the electrical arrangement 401 of FIG. 4. The features that remain unchanged are referred to using the same numeral, except for the first digit, which is “1” for the electrical arrangement 101 of FIGS. 1 and “4” for the electrical arrangement 401 of FIG. 4.

The DC-power supply device 400 further comprises a wireless-signal input unit 414 that is configured to receive the shutdown-request signal S1 via a wireless connection in accordance with a predetermined wireless communication protocol. In this electrical arrangement 401, the shutdown request signal is provided by a shutdown-condition control unit 450. The shutdown-condition control unit 450 comprises a shutdown-condition determination unit 452 that is configured to determine, based on a fulfillment of a predetermined shutdown condition, whether a shutdown of a DC-powered device 402a, 402b is required for a predetermined shutdown time-span. The shutdown-condition control unit 450 also comprises a shutdown-condition communication unit 454 connected to the shutdown-condition determination unit 452 and configured to provide, upon fulfillment of the shutdown condition, the shutdown-request signal S1 to the communication unit 408 of the DC-power supply device 400. In the electrical arrangement 401, the shutdown-condition control unit is a unit that is external to both the DC-power supply device 400 and the DC-powered devices 402a, 402b. The communication with the DC-power supply device is performed via a wireless connection. In another electrical arrangement, the shutdown-condition control unit is connected to a DC-power output interface and is configured to send the shutdown-request signal via the wired connection. In another electrical arrangement, one or more of the DC-powered devices comprises a shutdown-condition control unit as an internal unit. Even when connected to a DC-power output interface, a shutdown-condition control unit can be configured to provide shutdown-request signals for a DC-powered device connected to another DC-power output interface.

In an exemplary electrical arrangement, a DC-powered device comprises a lighting device, preferably comprising light emitting diodes, and more preferably compliant with the IEEE 802.3 standard.

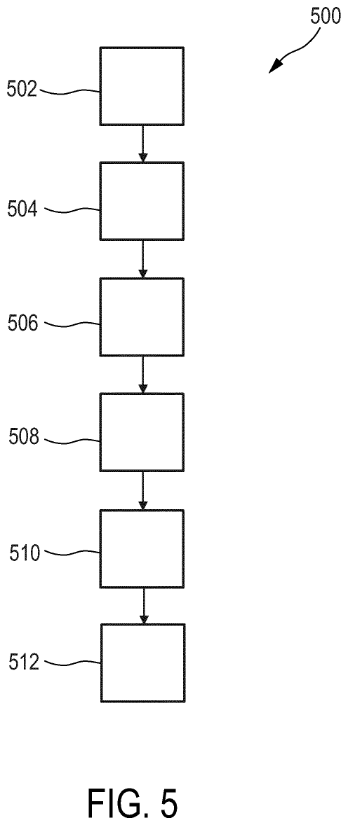

FIG. 5 shows a flow diagram of an embodiment of a method for operating a DC-power supply device for supplying operational DC power to an external DC-powered device via a wired connection. The DC-power supply device has a DC-power output interface for providing the operational DC power to the DC-powered device via the wired connection, the DC-power output interface being operable in a power-provision-enabled mode in which operational DC power is delivered to the DC-powered device upon request, and in a power-provision-disabled mode in which operational DC power is not delivered to the DC-powered device. The method comprises providing, in a step 502, receiving a shutdown-request signal indicative of a shutdown time-span during which no operational DC power is required by the DC-powered device and, in a step 504, providing to a power control unit, a shutdown-trigger signal indicative thereof. The method also comprises determining, in a step 506 a connected state, in which a DC-powered device is connected to the DC-power output interface via the wired connection, and a disconnected state, in which the wired connection is disconnected, and, in a step 580, providing, to a power control unit, a connection status signal indicative thereof. Upon reception of the shutdown-trigger signal, the method comprises, in a step 510, driving operation of the DC-power output interface in the power-provision-disabled mode during the shutdown time-span. Also, upon reception of the connection status signal indicative of the disconnected state, the method comprises, in a step 512, driving operation of the DC-power output interface in the power-provision-enabled mode, even when the shutdown time-span has not lapsed.

In summary, the invention relates to a DC-power supply device for supplying operational DC power to an external DC-powered device via a wired connection which comprises a DC-power output interface, a communication unit configured to receive a shutdown-request signal indicative of a shutdown time-span during which no operational DC power is required and to provide a shutdown-trigger signal, a DC-powered device detection unit configured to determine a connected state and a disconnected state of the DC-powered device and to provide a connection status signal indicative thereof, and a power control unit configured, upon reception of the shutdown-trigger signal, to disable provision of operational DC power during the shutdown time-span and, upon reception of the connection status signal indicative of the disconnected state, to re-enable provision of operational DC-power, thus improving a control of operational DC power provision.

In the claims, the word “comprising” does not exclude other elements or steps, and the indefinite article “a” or “an” does not exclude a plurality.

A single step or other units may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A DC-power supply device for supplying operational DC power to an external DC-powered device via a wired connection, the DC-power supply device comprising:
a DC-power output interface for providing the operational DC power to the DC-powered device via the wired connection, the DC-power output interface being operable in a power-provision-enabled mode in which operational DC power is deliverable to the DC-powered device upon request, and in a power-provision-disabled mode in which operational DC power is not deliverable to the DC-powered device;
a communication unit configured to receive a shutdown-request signal indicative of a shutdown time-span (ts) during which no operational DC power is required by the DC-powered device via the DC-power output interface, and to provide a shutdown-trigger signal indicative thereof; wherein the shutdown-request signal is provided via the wired connection by the DC-powered device;
a DC-powered device detection unit configured to detect a connected state, in which a DC-powered device is connected to the DC-power output interface via the wired connection, and to detect a disconnected state, in which the wired connection is disconnected, and to provide a connection status signal (S3) indicative thereof; wherein the connected state is an indication of whether there is a wired connection connecting the DC-power supply device and the DC-powered device; and
a power control unit connected to the DC-power output interface, to the communication unit and to the DC-powered device detection unit and configured:
to receive the shutdown-trigger signal and the connection status signal;
upon reception of the shutdown-trigger signal, to drive operation of
the DC-power output interface in the power-provision-disabled mode during the shutdown time-span; and
upon reception of the connection status signal indicative of the disconnected state, to drive operation of the DC-power output interface in the power-provision-enabled mode.

2. The DC-power supply device of claim 1, wherein the power control unit is further configured to drive operation of the DC-power output interface in the power-enabled mode upon expiration of the shutdown time-span.

3. The DC-power supply device of claim 1, wherein the DC-powered device detection unit, for detecting whether a DC-powered device is connected to the DC-power output interface, is configured:
to generate and provide, via the DC-power output interface and the wired connection, an electrical test signal having a predetermined voltage amount;
to determine whether or not a current amount provided via the DC-power output interface during provision of the electrical test signal has a current value within a predetermined current value range; and
to provide the connection status signal in dependence thereof.

4. The DC-power supply device of claim 1, wherein the DC-powered device detection unit, for detecting whether a DC-powered device is connected to the DC-power output interface, is configured:
to generate and provide, via the DC-power output interface and the wired connection, an electrical test signal a having predetermined voltage amount,
to determine whether or not an effective resistance connected to the DC-power output interface via the wired connection has a resistance value within a predetermined resistance value range; and
to provide the connection status signal in dependence thereof.

5. The DC-power supply device of claim 3, wherein
the DC-powered device detection unit is configured to generate and provide the electrical test signal as a pulse train, each pulse of the pulse train having a non-vanishing voltage amount only during a predetermined pulse-time span, the pulse train thus having a vanishing voltage amount between individual pulses, and wherein
the DC-powered device detection unit is configured to distinguish between the connected state and the disconnected state based on the current amount or the effective resistance detected during the pulse-time spans only.

6. The DC-power supply device of claim 1, wherein the communication unit comprises a wireless-signal input unit that is configured to receive the shutdown-request signal via a wireless connection in accordance with a predetermined wireless communication protocol.

7. The DC-power supply device of claim 1, wherein the communication unit is configured to receive the shutdown-request signal via the wired connection.

8. The DC-power supply of claim 7, wherein the communication unit is configured to receive the shutdown-request signal in accordance with a IEEE 802.3 protocol.

9. The DC-power supply of claim 7, wherein the communication unit is configured to receive the shutdown-request signal as a Logical Link Discovery Protocol frame in accordance with a Logical Link Discovery Protocol.

10. An electrical arrangement comprising:
a DC-power supply device in accordance with claim 1;
a DC-powered device, connected to the DC-power supply device via the wired connection, the DC-powered device comprising a DC-power input interface for receiving the operational DC electrical power from the DC-power supply device via the wired connection; and
a shutdown-condition control unit comprising:
a shutdown-condition determination unit configured to determine, based on a fulfillment of a predetermined shutdown condition, whether a shutdown of the DC-powered device is required for a predetermined shutdown time-span; and
a shutdown-condition communication unit connected to the shutdown-condition determination unit and configured to provide, upon fulfillment of the shutdown condition, the shutdown-request signal to the DC-power supply device; wherein the shutdown-request signal is provided via the wired connection by the DC-powered device.

11. The electrical arrangement of claim 10, wherein the DC-powered device comprises the shutdown-condition control unit as an internal unit connected to the DC-power input interface.

12. The electrical arrangement of claim 11, wherein the shutdown-condition communication unit is configured to provide the shutdown request signal to the DC-power supply device via the wired connection.

13. The electrical arrangement of claim 10, wherein the DC-powered device comprises a lighting device for providing indoor or outdoor illumination, the lighting device being configured to receive operational DC-power from the DC-power supply device via the wired connection.

14. A method for operating a DC-power supply device for supplying operational DC power to an external DC-powered device via a wired connection, the DC-power supply device having a DC-power output interface for providing the operational DC power to the DC-powered device via the wired connection, the DC-power output interface being operable in a power-provision-enabled mode in which operational DC power is deliverable to the DC-powered device upon request, and in a power-provision-disabled mode in which operational DC power is not deliverable to the DC-powered device, the method comprising
receiving a shutdown-request signal indicative of a shutdown time-span during which no operational DC power is required by the DC-powered device via the DC-power output interface and providing, to a power control unit, a shutdown-trigger signal indicative thereof; wherein the shutdown-request signal is provided via the wired connection by the DC-powered device;
determining a connected state, in which a DC-powered device is connected to the DC-power output interface via the wired connection, and a disconnected state, in which the wired connection is disconnected, and providing, to a power control unit, a connection status signal indicative thereof; wherein the connected state is an indication of whether there is a wired connection connecting the DC-power supply device and the DC-powered device;
upon reception of the shutdown-trigger signal, driving operation of the DC-power output interface in the power-provision-disabled mode during the shutdown time-span; and
upon reception of the connection status signal indicative of the disconnected state, driving operation of the DC-power output interface in the power-provision-enabled mode, even when the shutdown time-span has not lapsed.

15. A computer program comprising instructions which, when the program is executed by a computer, cause the computer to carry out the method of claim 14.
